(19) United States
(12) Patent Application Publication
(10) Pub. No.: US 2010/0188414 A1
(43) Pub. Date: Jul. 29, 2010

(54) METHOD AND LOGGING SYSTEM FOR TRACKING ACTIVITY DATA OF A MEDICAL SCANNING APPARATUS

(75) Inventor: Hermanus Cornelis Weijers, Haaren (NL)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., Eindhoven (NL)

(21) Appl. No.: 12/665,946

(22) PCT Filed: Jun. 25, 2008
(86) PCT No.: PCT/IB2008/052527

§ 371 Date: Dec. 22, 2009

(30) Foreign Application Priority Data
Jun. 29, 2007 (EP) 07111470.6

(51) Int. Cl. G06T 11/20; G09G 5/02

(52) U.S. Cl. 345/589; 345/440; 345/440.2

(57) ABSTRACT

The invention relates to a logging system for tracking activity-data relating to at least one medical scanning-apparatus, having input means for collecting said activity-data, a data processor, storage means for storing said activity-data, and display means for storing said collected activity-data, wherein the display means are arranged to show said collected activity-data in a graph, wherein said graph comprises a plurality of adjacent display-elements, each display-element representing a predetermined time-frame and neighboring display-elements representing consecutive time-frames, wherein all display-elements together represent at least a complete operational cycle of said medical scanning apparatus, and wherein in use each display-element concerning a passed timeframe is fully covered by a mark or a series of marks, wherein each mark represents one predetermined activity and its duration, each of said marks being selected in dependence of the activity-data collected with said input means.

### FIELD OF THE INVENTION

The invention relates to a method and apparatus for tracking activity-data relating to at least one medical scanning-apparatus, having input means for collecting said activity-data, a data processor, storage means for storing said activity-data, and display means for storing said collected activity-data, wherein the display means are arranged to show said collected activity-data in a graph.

Practice shows that there is a need to increase and intensify the use that is made of such medical scanning apparatuses, such as MRI-scanning systems, CT-scanning systems and other imaging systems that are used in the medical field.

Such imaging systems involve high investments which must be utilized as efficiently as possible without sacrificing patient care and the quality of the diagnostics. At the same time it is essential to limit downtime and to secure that the staff that is operating the medical scanning apparatus is not only capable but also well trained to perform all diagnostic operations as efficient as possible to ensure an optimal return on investment.

The invention is aimed at providing a method and logging system which make it possible to achieve these aims.

According to the invention a logging system and a method for tracking activity data relating to at least one scanning apparatus are therefore proposed according to one or more of the appended claims.

In a first aspect of the invention the logging system is characterized in that the graph shown on the display means comprises a plurality of adjacent display-elements, each display-element representing a predetermined time-frame and neighboring display-elements representing consecutive time-frames, wherein all display-elements together represent at least a complete operational cycle of said medical scanning apparatus, and in that in use each display-element concerning a passed time-frame is fully covered by a mark or a series of marks, wherein each mark represents one predetermined activity and its duration, each of said marks being selected in dependence of the activity-data collected with the input means.

In this way the graph provides immediately accessible information regarding the efficiency in the workflow pertaining to the medical scanning apparatus, from which it is also immediately apparent where improvements are attainable.

In order to support the ease of interpretation of said graph each mark comprises two feature-elements, a first feature element being characteristic for the activity and the second feature element being characteristic for the duration of the activity.

It appears that the aims of the invention are best achieved when the first feature element is a predetermined color or grey-level and the second feature element is a dimension of the mark, preferably a part of the area that the display element covers, whereby the surface-area covered by said mark corresponds with the ratio of the duration of the concerning activity in relation to the complete timeframe covered by said display element.

A very effective way of implementing the graph is by arranging said display elements as bars. Preferably each bar represents one clock hour. In this way the working hours of a day can be arranged next and consecutive to each other and the full 24 hours of a day can be shown in a single graph.

The logging system and method of the invention is further preferably so arranged that the at least one scanning apparatus connects to the input means through internet. By this measure it is possible to centrally collect the activity data of a series of medical scanning apparatuses that are distributed throughout the world, without the need to have a dedicated logging system located at the spot of every and each medical scanning apparatus.

Particularly in this latter situation wherein the logging system is placed centrally, it is advantageous to apply further display means that are placed where the at least one medical scanning apparatus is housed, and that said further display means are arranged to show the collected activity data of said medical scanning apparatus in the manner as discussed hereabove.

As mentioned above the invention concerns both a method and a logging system for tracking activity data relating to at least one medical scanning apparatus.

The invention is however also embodied in software for carrying out this method by implementing it to operate in a logging system of the invention as described above.

The method and the logging system of the invention will hereinafter be further elucidated with reference to an exemplary embodiment of the invention and with reference to the drawing.

### BRIEF DESCRIPTION OF THE DRAWINGS

The drawing shows in:

FIG. 1 a logging system of the invention for tracking activity data of distributed medical scanning apparatuses;

FIG. 2 a typical example of a graph showing the activity data pertaining to a scanning apparatus, and

FIGS. 3a, 3b and 3c examples of the graph shown in FIG. 2 representing different activity patterns of a medical scanning apparatus.

### DETAILED DESCRIPTION OF PREFERRED EMBODIMENTS

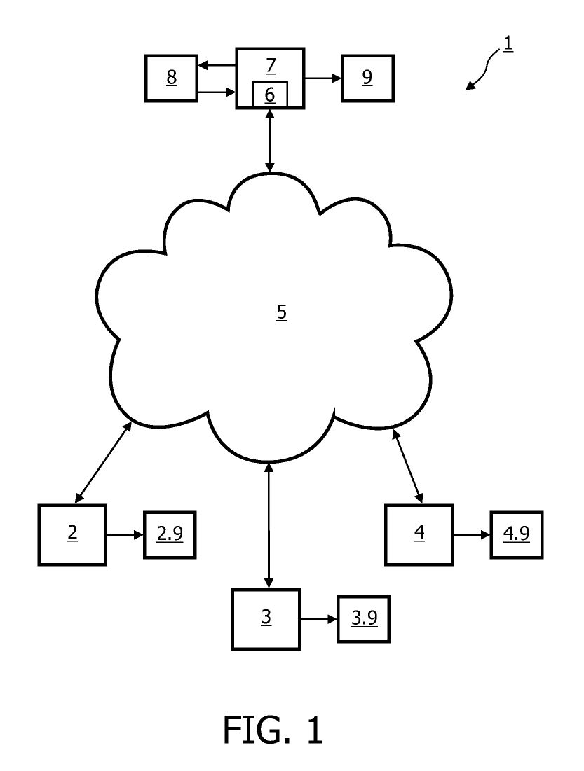

Referring first to FIG. 1 a logging system 1 is shown for tracking activity data relating to at least one and in this example three medical scanning apparatuses 2, 3 and 4.

To collect the medical activity data of said medical scanning apparatuses 2, 3 and 4 the logging system 1 is connected to said apparatus 2, 3 and 4 by means of a data exchange network 5, for example the internet. In such an arrangement it is possible to locate the logging system 1 in one country, the medical scanning apparatus 2 in a second country, the medical scanning apparatus 3 in a third country and the medical scanning apparatus 4 in a fourth country.

In order to collect the data from the medical scanning apparatuses 2, 3 and 4 through the information network 5, the logging system 1 is provided with input means 6. The logging system 1 is further provided with a data processor 7, and with storage means 8 for storing and retrieving the activity data from said medical scanning apparatuses 2, 3 and 4. Further there are display means 9 for showing such collected activity data pertaining to the medical scanning apparatuses 2, 3 and 4, wherein the display means 9 are arranged to show the collected activity data in a graph.

Within the scope of the invention it is also possible to have the display means 9 located near or at the respective medical scanning apparatuses 2, 3 and 4, in which case the graph that is shown on any of such displays 2.9, 3.9 and 4.9 is dedicated to show the activity data pertaining to respectively the medical scanning apparatus 2, the medical scanning apparatus 3 or the medical scanning apparatus 4. In this way it may be prevented that information pertaining to the working habits of an operating team working with for instance medical scanning apparatus 2 are available to the persons that are involved with the medical scanning apparatus 3 or medical scanning apparatus 4 and vice versa.

It goes without saying that the said further display means 2.9, 3.9 and 4.9 are fed with information from the logging system 1 which is centrally located through the information network 5, whereby said further display means 2.9, 3.9 and 4.9 are directly connected to their own computer which need not be in the direct vicinity of the corresponding medical scanning apparatus 2, 3 or 4, but for instance in the office of an officer who is responsible for the efficient utilization of the concerning scanning apparatus 2, 3 or 4.

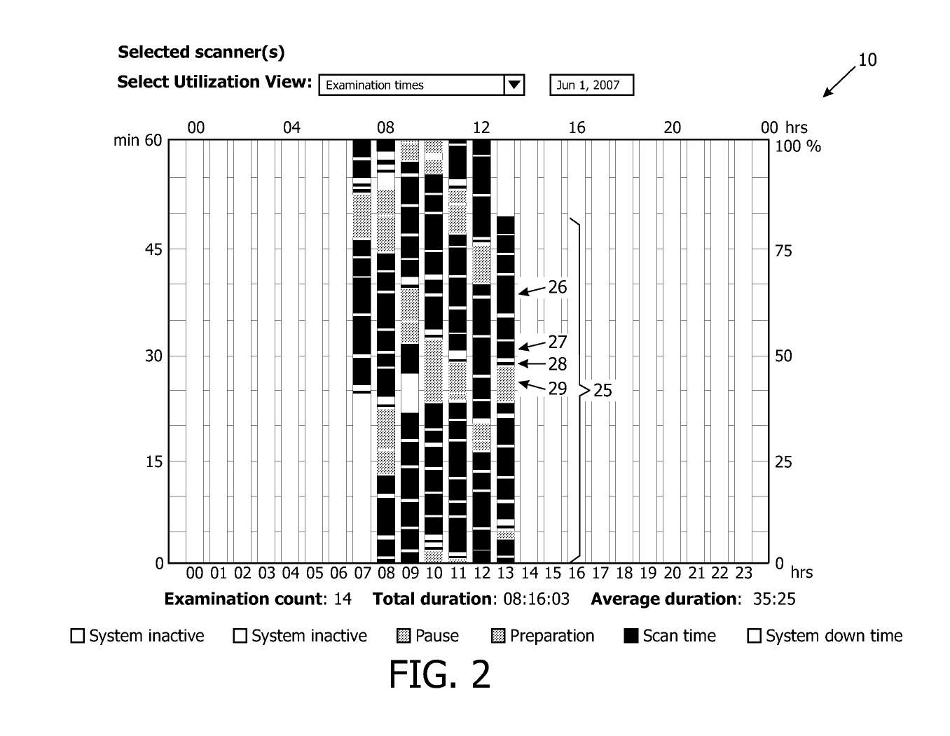

Turning now to FIG. 2, an example of a graph 10 is shown for displaying the collected activity data of a medical scanning apparatus 2, 3, 4 in a manner that allows easy access and a one view perception of the utilization of said medical scanning apparatus 2, 3 and 4.

The graph 10 incorporates to this end a plurality of adjacent display elements that are numbered 00, 01, 02, . . . , 20, 21, 22, 23.

Each display element 00, . . . , 23 represents thereby a predetermined timeframe, in this particular shown case one clock hour. As an example display element 08 concerns the clock hour starting at 7:00 hours and ending at 7:59 hours. In the manner as shown the neighboring display elements 00, . . . , 23 represent consecutive timeframes of one clock hour and all display elements together represent a complete operational cycle of the concerning medical scanning apparatus 2, 3, 4. In this example the display elements together represent a full 24 hour day. But it can also be elected to have the display elements refer only to the hours of a day in which the medical scanning apparatus 2, 3, 4 is actually used. For instance, starting at 5:00 hours and ending on 20:00 hours on a particular day.

The graph 10 shows that each display element representing one clock hour is divided by a series of marks, as for example the series of marks 25 relating to display element 13 shown in graph 10. Said marks 25 are shown as a part of each display element in dependence of the activity data collected with the input means 6 as shown in FIG. 1, and relate to the concerning medical scanning apparatus 2, 3, 4 to which the graph 10 pertains.

As the series of marks 25 shows each mark, for instance each of the marks 26, 27, 28 and 29, comprises two feature elements, a first feature element being characteristic for the activity and the second feature element being characteristic for the duration of the activity.

Concerning the first feature element there is notable difference between the marks 26, 27 and 28 as compared to the mark 29, in that the marks 26, 27 and 28 are black and mark 29 is grey. This first feature element of the concerning marks is characteristic for the type of activity of the concerning medical scanning apparatus 2, 3, 4. The black mark 26, 27, 28 relates to a scanning activity of the apparatus, whereas the grey mark 29 corresponds to preparation time in advance of the subsequent scanning operation 28. Also for other possible activities or inactivities different grey levels or predetermined colors can be applied.

A second feature that is characteristic for the duration of the activity pertains to each mark of the series of marks 25. This second feature element is a dimension of the mark 26, 27, 28, 29 and is preferably indicated as a part of the area of the entire display element 13, the magnitude of which part corresponds to the ratio of the duration of the concerning activity indicated by the mark, as compared to the complete timeframe that is covered by the display element and that represents the clock hour during which the activity occurs.

FIG. 2 shows that the display elements 00, . . . , 23 are shaped as bars which appears to be a very effective and intuitive way of representing the utilization of the medical scanning apparatus.

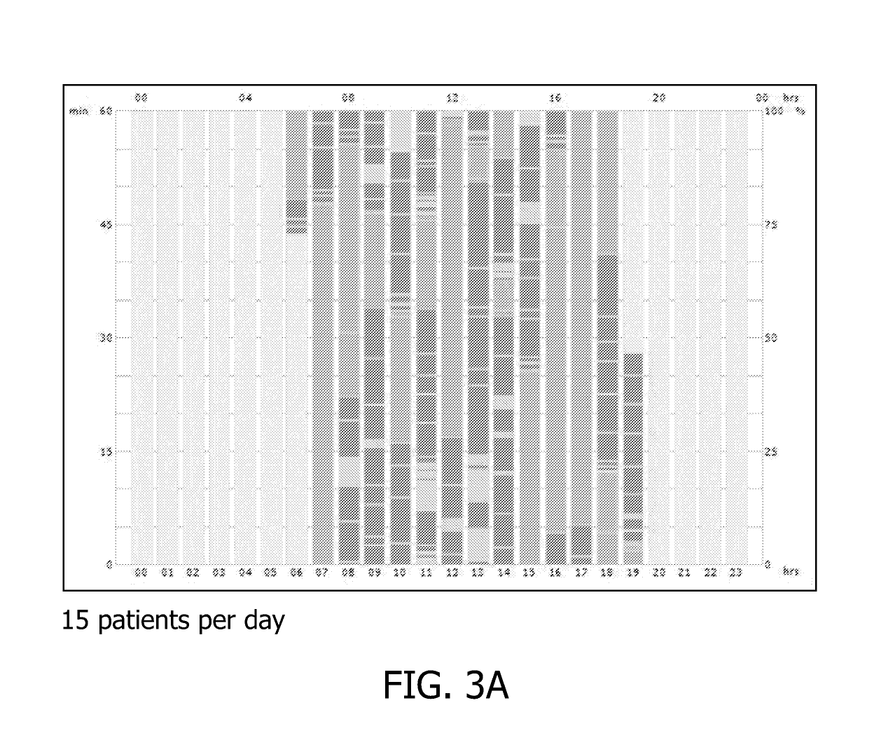

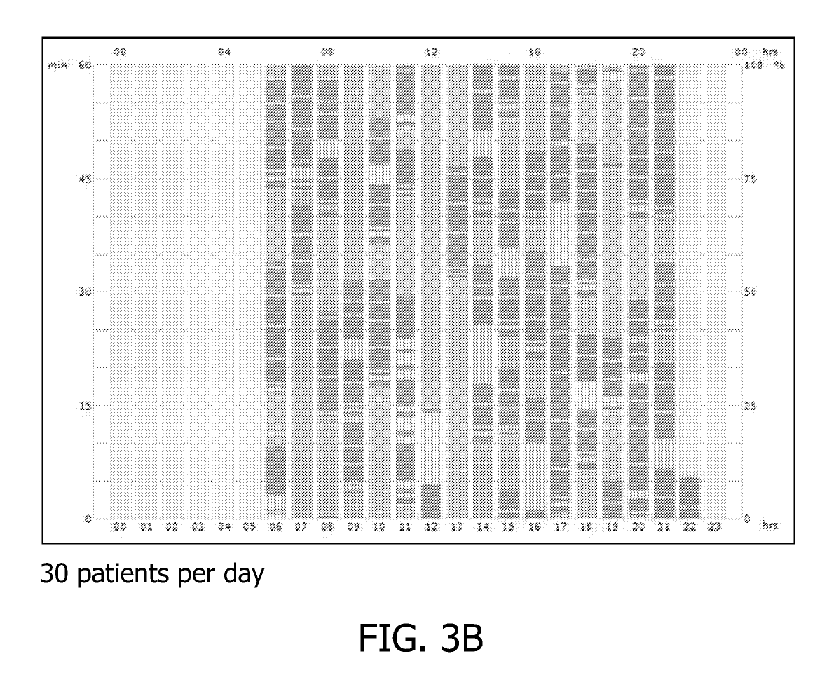

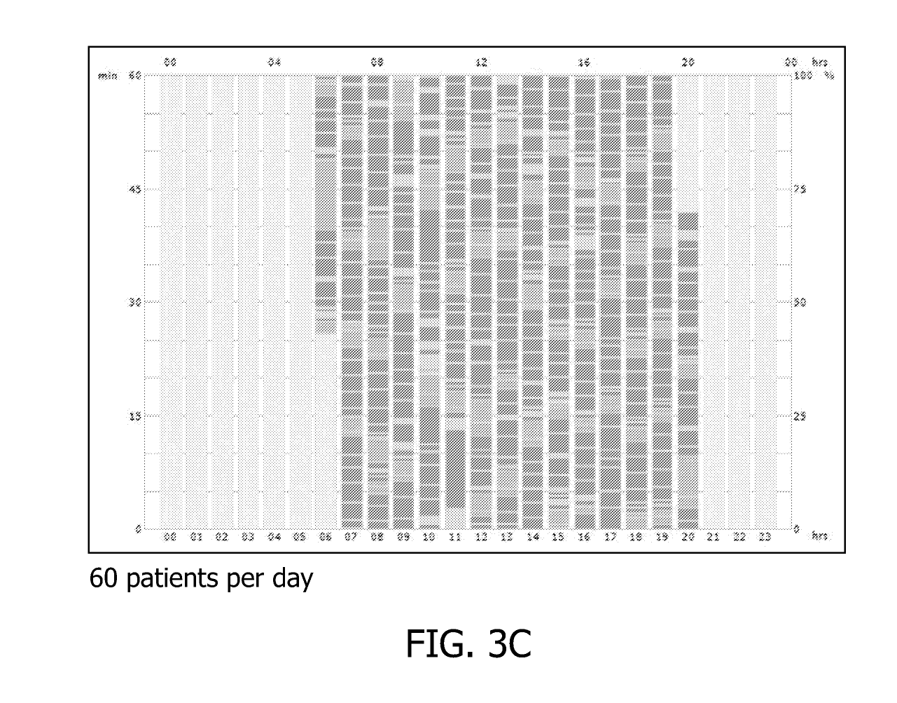

Turning now to FIG. 3 a comparative example is shown of the utilization of a medical scanning apparatus which can be read from a graph as shown in FIG. 2.

FIG. 3a shows the utilization at a day during which 15 patients are scanned. FIG. 3b shows a day at which 30 patients are scanned and FIG. 3c shows a day at which 60 patients a day are scanned. What strikes the observer of these graphs shown in FIG. 3a, FIG. 3b and FIG. 3c, respectively, is that a very effective and immediately accessible and apparent insight is offered to the observer on the utilization of the medical scanning apparatus 2, 3, 4 to which the graph shown pertains. Also the graph offers so much insight that the fields of improvement are easily identifiable.

It goes without saying that by means of the method and logging system provided by the invention the user of the medical scanning apparatus who is informed about its utilization, can very well decide on the measures to be taken for improvement. It is also possible to provide such user with comparative examples from other medical scanning apparatuses in order to learn what level of utilization is feasible and how these higher levels are attainable.

Method and logging system for tracking activity data of a medical scanning apparatus

### FIELD OF THE INVENTION

The invention relates to a method and apparatus for tracking activity-data relating to at least one medical scanning-apparatus, having input means for collecting said activity-data, a data processor, storage means for storing said activity-data, and display means for storing said collected activity-data, wherein the display means are arranged to show said collected activity-data in a graph.

Practice shows that there is a need to increase and intensify the use that is made of such medical scanning apparatuses, such as MRI-scanning systems, CT-scanning systems and other imaging systems that are used in the medical field.

Such imaging systems involve high investments which must be utilized as efficiently as possible without sacrificing patient care and the quality of the diagnostics. At the same time it is essential to limit downtime and to secure that the staff that is operating the medical scanning apparatus is not only capable but also well trained to perform all diagnostic operations as efficient as possible to ensure an optimal return on investment.

The invention is aimed at providing a method and logging system which make it possible to achieve these aims.

According to the invention a logging system and a method for tracking activity data relating to at least one scanning apparatus are therefore proposed according to one or more of the appended claims.

In a first aspect of the invention the logging system is characterized in that the graph shown on the display means comprises a plurality of adjacent display-elements, each display-element representing a predetermined time-frame and neighboring display-elements representing consecutive time-frames, wherein all display-elements together represent at least a complete operational cycle of said medical scanning apparatus, and in that in use each display-element concerning a passed time-frame is fully covered by a mark or a series of marks, wherein each mark represents one predetermined activity and its duration, each of said marks being selected in dependence of the activity-data collected with the input means.

In this way the graph provides immediately accessible information regarding the efficiency in the workflow pertaining to the medical scanning apparatus, from which it is also immediately apparent where improvements are attainable.

In order to support the ease of interpretation of said graph each mark comprises two feature-elements, a first feature element being characteristic for the activity and the second feature element being characteristic for the duration of the activity.

It appears that the aims of the invention are best achieved when the first feature element is a predetermined color or grey-level and the second feature element is a dimension of the mark, preferably a part of the area that the display element covers, whereby the surface-area covered by said mark corresponds with the ratio of the duration of the concerning activity in relation to the complete timeframe covered by said display element.

A very effective way of implementing the graph is by arranging said display elements as bars. Preferably each bar represents one clock hour. In this way the working hours of a day can be arranged next and consecutive to each other and the full 24 hours of a day can be shown in a single graph.

The logging system and method of the invention is further preferably so arranged that the at least one scanning apparatus connects to the input means through internet. By this measure it is possible to centrally collect the activity data of a series of medical scanning apparatuses that are distributed throughout the world, without the need to have a dedicated logging system located at the spot of every and each medical scanning apparatus.

Particularly in this latter situation wherein the logging system is placed centrally, it is advantageous to apply further display means that are placed where the at least one medical scanning apparatus is housed, and that said further display means are arranged to show the collected activity data of said medical scanning apparatus in the manner as discussed hereabove.

As mentioned above the invention concerns both a method and a logging system for tracking activity data relating to at least one medical scanning apparatus.

The invention is however also embodied in software for carrying out this method by implementing it to operate in a logging system of the invention as described above.

The method and the logging system of the invention will hereinafter be further elucidated with reference to an exemplary embodiment of the invention and with reference to the drawing.

### BRIEF DESCRIPTION OF THE DRAWINGS

The drawing shows in:

FIG. 1 a logging system of the invention for tracking activity data of distributed medical scanning apparatuses;

FIG. 2 a typical example of a graph showing the activity data pertaining to a scanning apparatus, and

FIGS. 3a, 3b and 3c examples of the graph shown in FIG. 2 representing different activity patterns of a medical scanning apparatus.

### DETAILED DESCRIPTION OF PREFERRED EMBODIMENTS

Referring first to FIG. 1 a logging system 1 is shown for tracking activity data relating to at least one and in this example three medical scanning apparatuses 2, 3 and 4.

To collect the medical activity data of said medical scanning apparatuses 2, 3 and 4 the logging system 1 is connected to said apparatus 2, 3 and 4 by means of a data exchange network 5, for example the internet. In such an arrangement it is possible to locate the logging system 1 in one country, the medical scanning apparatus 2 in a second country, the medical scanning apparatus 3 in a third country and the medical scanning apparatus 4 in a fourth country.

In order to collect the data from the medical scanning apparatuses 2, 3 and 4 through the information network 5, the logging system 1 is provided with input means 6. The logging system 1 is further provided with a data processor 7, and with storage means 8 for storing and retrieving the activity data from said medical scanning apparatuses 2, 3 and 4. Further there are display means 9 for showing such collected activity data pertaining to the medical scanning apparatuses 2, 3 and 4, wherein the display means 9 are arranged to show the collected activity data in a graph.

Within the scope of the invention it is also possible to have the display means 9 located near or at the respective medical scanning apparatuses 2, 3 and 4, in which case the graph that is shown on any of such displays 2.9, 3.9 and 4.9 is dedicated to show the activity data pertaining to respectively the medical scanning apparatus 2, the medical scanning apparatus 3 or the medical scanning apparatus 4. In this way it may be prevented that information pertaining to the working habits of an operating team working with for instance medical scanning apparatus 2 are available to the persons that are involved with the medical scanning apparatus 3 or medical scanning apparatus 4 and vice versa.

It goes without saying that the said further display means 2.9, 3.9 and 4.9 are fed with information from the logging system 1 which is centrally located through the information network 5, whereby said further display means 2.9, 3.9 and 4.9 are directly connected to their own computer which need not be in the direct vicinity of the corresponding medical scanning apparatus 2, 3 or 4, but for instance in the office of an officer who is responsible for the efficient utilization of the concerning scanning apparatus 2, 3 or 4.

Turning now to FIG. 2, an example of a graph 10 is shown for displaying the collected activity data of a medical scanning apparatus 2, 3, 4 in a manner that allows easy access and a one view perception of the utilization of said medical scanning apparatus 2, 3 and 4.

The graph 10 incorporates to this end a plurality of adjacent display elements that are numbered 00, 01, 02, . . . , 20, 21, 22, 23.

Each display element 00, . . . , 23 represents thereby a predetermined timeframe, in this particular shown case one clock hour. As an example display element 08 concerns the clock hour starting at 7:00 hours and ending at 7:59 hours. In the manner as shown the neighboring display elements 00, . . . , 23 represent consecutive timeframes of one clock hour and all display elements together represent a complete operational cycle of the concerning medical scanning apparatus 2, 3, 4. In this example the display elements together represent a full 24 hour day. But it can also be elected to have the display elements refer only to the hours of a day in which the medical scanning apparatus 2, 3, 4 is actually used. For instance, starting at 5:00 hours and ending on 20:00 hours on a particular day.

The graph 10 shows that each display element representing one clock hour is divided by a series of marks, as for example the series of marks 25 relating to display element 13 shown in graph 10. Said marks 25 are shown as a part of each display element in dependence of the activity data collected with the input means 6 as shown in FIG. 1, and relate to the concerning medical scanning apparatus 2, 3, 4 to which the graph 10 pertains.

As the series of marks 25 shows each mark, for instance each of the marks 26, 27, 28 and 29, comprises two feature elements, a first feature element being characteristic for the activity and the second feature element being characteristic for the duration of the activity.

Concerning the first feature element there is notable difference between the marks 26, 27 and 28 as compared to the mark 29, in that the marks 26, 27 and 28 are black and mark 29 is grey. This first feature element of the concerning marks is characteristic for the type of activity of the concerning medical scanning apparatus 2, 3, 4. The black mark 26, 27, 28 relates to a scanning activity of the apparatus, whereas the grey mark 29 corresponds to preparation time in advance of the subsequent scanning operation 28. Also for other possible activities or inactivities different grey levels or predetermined colors can be applied.

A second feature that is characteristic for the duration of the activity pertains to each mark of the series of marks 25. This second feature element is a dimension of the mark 26, 27, 28, 29 and is preferably indicated as a part of the area of the entire display element 13, the magnitude of which part corresponds to the ratio of the duration of the concerning activity indicated by the mark, as compared to the complete timeframe that is covered by the display element and that represents the clock hour during which the activity occurs.

FIG. 2 shows that the display elements 00, . . . , 23 are shaped as bars which appears to be a very effective and intuitive way of representing the utilization of the medical scanning apparatus.

Turning now to FIG. 3 a comparative example is shown of the utilization of a medical scanning apparatus which can be read from a graph as shown in FIG. 2.

FIG. 3a shows the utilization at a day during which 15 patients are scanned. FIG. 3b shows a day at which 30 patients are scanned and FIG. 3c shows a day at which 60 patients a day are scanned. What strikes the observer of these graphs shown in FIG. 3a, FIG. 3b and FIG. 3c, respectively, is that a very effective and immediately accessible and apparent insight is offered to the observer on the utilization of the medical scanning apparatus 2, 3, 4 to which the graph shown pertains. Also the graph offers so much insight that the fields of improvement are easily identifiable.

It goes without saying that by means of the method and logging system provided by the invention the user of the medical scanning apparatus who is informed about its utilization, can very well decide on the measures to be taken for improvement. It is also possible to provide such user with comparative examples from other medical scanning apparatuses in order to learn what level of utilization is feasible and how these higher levels are attainable.

1. A logging system for tracking activity-data relating to at least one medical scanning-apparatus, having input means for collecting said activity-data, a data processor, storage means for storing said activity-data, and display means for storing said collected activity-data, wherein the display means are arranged to show said collected activity-data in a graph, wherein said graph comprises a plurality of adjacent display-elements, each display-element representing a predetermined time-frame and neighboring display-elements representing consecutive time-frames, wherein all display-elements together represent at least a complete operational cycle of said medical scanning apparatus, and in that in use each display-element concerning a passed timeframe is fully covered by a mark or a series of marks, wherein each mark represents one predetermined activity and its duration, each of said marks being selected in dependence of the activity-data collected with said input means.

2. The logging system according to claim 1, wherein each mark comprises two feature-elements, a first feature element being characteristic for the activity and the second feature element being characteristic for the duration of the activity.

3. The logging system according to claim 2, wherein the first feature element is a predetermined color or grey-level.

4. The logging system according to claim 2, wherein the second feature element is a dimension of the mark, preferably a part of the area the display-element covers, the extent of the area covered by said part corresponding with the ratio of the duration of the concerning activity in relation to the complete time frame covered by said display-element.

5. The logging system according to claim 1, wherein the display-elements are bars.

6. The logging system according to claim 5, wherein each bar represents one clock-hour.

7. The logging system according to claim 1, wherein the at least one medical scanning-apparatus connects to the input means through internet.

8. The logging system, wherein further display means are provided that are placed near or at the location of the at least one medical scanning apparatus, wherein said further display means are arranged to show the collected activity-data of said medical scanning apparatus in accordance with claim 1.

9. A method for tracking activity-data relating to at least one medical scanning-apparatus, comprising collecting said activity-data, processing and storing said activity-data, and displaying said activity-data in a graph, wherein said graph comprises a plurality of adjacent display-elements, each display-element representing a predetermined time-frame and neighboring display-elements representing consecutive time-frames, wherein all display-elements together represent at least a complete operational cycle of said medical scanning apparatus, and in that each display-element is fully covered by a mark or a series of marks, wherein each mark represents one predetermined activity and its duration, each of said marks being selected in dependence of the collected activity-data.

10. Software for tracking activity-data relating to at least one medical scanning-apparatus, comprising instructions for collecting said activity-data, processing and storing said activity-data, and displaying said activity-data in a graph, wherein said graph comprises a plurality of adjacent display-elements, each display-element representing a predetermined time-frame and neighboring display-elements representing consecutive time-frames, wherein all display-elements together represent at least a complete operational cycle of said medical scanning apparatus, and in that each display-element is fully covered by a mark or a series of marks, wherein each mark represents one predetermined activity and its duration, each of said marks being selected in dependence of the collected activity-data.
